(19) United States
(12) Patent Application Publication
(10) Pub. No.: US 2012/0305802 A1
(43) Pub. Date: Dec. 6, 2012

(54) Nanoparticles and Methods of Generating Coherent Emission Therefrom

(76) Inventors: Erik Herz, Brookhaven, PA (US); Andrew Burns, Niskayuna, NY (US); Ulrich B. Wiesner, Ithaca, NY (US); Mikhail A. Noginov, Virginia Beach, VA (US); Samantha Stout, La Jolla, CA (US); Akeisha Belgrave, Plainville, CT (US); Guohua Zhu, Norfolk, VA (US); Vladimir M. Shalaev, West Lafayette, IN (US); Evgueni E. Narimanov, West Lafayette, IN (US)

(21) Appl. No.: 13/389,681

(22) PCT Filed: Aug. 11, 2010
(86) PCT No.: PCT/US10/45170

§ 371 Date: Aug. 22, 2012

Related U.S. Application Data
(60) Provisional application No. 61/232,991, filed on Aug. 11, 2009.

(51) Int. Cl. C09K 11/06; G01N 21/64; B82Y 30/00; B82Y 40/00; B82Y 20/00

(52) U.S. Cl. 250/459.1; 252/301.33; 977/773; 977/901; 977/755

(57) ABSTRACT

Nanoparticles with a metal or metallic core and an outer shell comprising a matrix and a dopant. For example, a nanoparticle can have a gold core and outer shell comprising silica and an organic dye. Such nanoparticles can have use in, for example, optical communication applications, chemical and biosensing applications, and imaging applications.

### CROSS-REFERENCE TO RELATED APPLICATIONS

This application claims priority to U.S. provisional patent application No. 61/232,991, filed Aug. 11, 2009, the disclosure of which is incorporated herein by reference.

### STATEMENT REGARDING FEDERALLY SPONSORED RESEARCH

This invention was made with government support under grant number M01-8407 awarded by the National Science Foundation (PREM). The government has certain rights in the invention.

### FIELD OF THE INVENTION

The present invention generally relates to nanostructures which can emit coherent radiation and methods of making such nanostructures. More particularly, the invention relates to nanoparticles which have a metal or metallic core and an outer shell, which has a matrix material and a dopant.

### BACKGROUND OF THE INVENTION

One of the most rapidly growing areas of physics and nanotechnology focuses on plasmonic effects on the nanometer scale, with possible applications ranging from sensing and biomedicine to imaging and information technology. However, the full development of nanoplasmonics is hindered by the lack of devices that can generate coherent plasmonic fields. It has been proposed that in the same way as a laser generates stimulated emission of coherent photons, a ‘spaser’ (surface plasmon (SP) amplification by stimulated emission of radiation) could generate stimulated emission of surface plasmons (oscillations of free electrons in metallic nanostructures) in resonating metallic nanostructures adjacent to a gain medium. But attempts to realize a spaser face the challenge of absorption loss in metal, which is particularly strong at optical frequencies.

### BRIEF SUMMARY

In one aspect, the present invention provides nanoparticles capable of providing stimulated emission of radiation from surface plasmons comprising: a metallic core which supports surface plasmon oscillations; and an outer shell comprising a matrix and a dopant (or dopants). The dopant has a dopant emission band, and the dopant is in proximity to the metallic core such that the nanoparticle exhibits coherent emission on exposure of the nanoparticle to an energy source. Optionally, the nanoparticle has a boundary layer (e.g., sodium silicate) disposed between the inner metallic core and outer doped shell. In one embodiment, the nanoparticle is spherical. In one embodiment, the longest dimension of the nanoparticle is from 2 nm to 200 nm. In one embodiment, the nanoparticle can emit coherent radiation in the visible range (e.g., from 800 nm to 400 nm).

In one embodiment, the metallic core is gold and the metallic core has a diameter of 10 nm to 100 nm. In one embodiment, matrix material is silica. In one embodiment, the thickness of the outer doped shell is from 2 nm to 100 nm. In one embodiment, the dopant is an organic dye. In one embodiment, the dopant is covalently bound to the matrix.

In another aspect, the present invention provides a method for producing coherent emission from a nanostructure comprising the steps of: providing a nanostructure (e.g., a nanoparticle) comprising a metallic structure capable of supporting surface plasmon oscillations, and a gain medium comprising a dopant and matrix material; and exposing the nanostructure to energy such that the dopant transfers energy to the surface plasmon oscillations of the metallic structure resulting coherent emission from the surface plasmon oscillations.

### BRIEF DESCRIPTION OF THE FIGURES

FIG. 1. An example of a nanostructure spaser design. a, Diagram of a hybrid nanoparticle architecture (not to scale), indicating dye molecules throughout the silica shell. b, Transmission electron microscope image of an Au core. c, Scanning electron microscope image of Au/silica/dye core-shell nanoparticles. d, Spaser mode (in false color), with λ=525 nm and Q=14.8; the inner and the outer circles represent the 14-nm core and the 44-nm shell, respectively. The field intensity color scheme is shown on the right.

FIG. 2. Normalized extinction (1), excitation (2), spontaneous emission (3), and stimulated emission (4) spectra of an example of Au/silica/dye nanoparticles. The peak extinction cross section of nanoparticles is equal to 1.1×10⁻¹² cm². The emission and excitation spectra were measured in a spectrofluorometer at low fluence.

FIG. 3. Example of emission kinetics. Main panel, emission kinetics detected at 480 nm (1) and 520 nm (2). Inset, trace 1 plotted in semi-logarithmic coordinates (dots) and the corresponding fitting curve. The beginning of each emission kinetic trace coincides with the 90-ps pumping pulse.

FIG. 4. Example of stimulated emission, a, Main panel, stimulated emission spectra of the nanoparticle sample pumped with 22.5 mJ (1), 9 mJ (2), 4.5 mJ (3), 2 mJ (4) and 1.25 mJ (5) 5-ns optical parametric oscillator pulses at λ=488 nm. b, Main panel, corresponding input-output curve (lower axis, total launched pumping energy; upper axis, absorbed pumping energy per nanoparticle); for most experimental points, 5% error bars (determined by the noise of the photodetector and the instability of the pumping laser) do not exceed the size of the symbol. Inset of a, stimulated emission spectrum at more than 100-fold dilution of the sample. Inset of b, the ratio of the stimulated emission intensity (integrated between 526 nm and 537 nm) to the spontaneous emission background (integrated at <526 nm and >537 nm).

### DETAILED DESCRIPTION OF THE INVENTION

The present invention provides nanoparticles which emit stimulated emission and methods of making such nanoparticles. Without intending to be bound by any particular theory it is considered that the nanoparticles emit stimulated emission from surface plasmons (SPs).

The present invention is based on energy coupling between two media within the confines of a nanostructure (such as a nanoparticle) such that loss of localized SPs (e.g., Joule losses) is reduced or overcome resulting in stimulated SP emission. This can be accomplished, for example, in a nanostructure which has a medium with optical gain in close proximity to a metallic nanostructure that exhibits surface plasmon oscillations. SP modes are desirable as these modes do not undergo radiative losses. In one embodiment, this energy coupling is achieved in the form of a nanoparticle which comprises an inner metallic core and an outer doped shell (also referred to herein as a spaser). It is considered that the doped shell acts as a gain medium. If the energy from the gain medium coupled to SP oscillations is greater than non-radiative losses of the oscillations, the nanoparticles can provide “laser-like” emission, hence the term spaser.

In an aspect, the present invention provides a method for generating coherent radiation from a nanostructure of the present invention. The method comprises the steps of providing a nanostructure (e.g., a nanoparticle) with a metallic core, dopant and gain medium in such proximity that energy from the dopant is coupled to the surface plasmon oscillations of the metallic core, and exposing the nanostructure to energy such that the dopant transfers energy to the surface plasmon oscillations of the metallic structure resulting in emission of coherent radiation from the surface plasmon oscillations.

The nanostructures of the present invention generate coherent and strong local fields. Such nanolocalized fields are desirable as they do not emit background radiation. The wavelength of the coherent radiation which is emitted by the nanostructures can be in the ultraviolet to visible to near-infrared range. For example, the coherent radiation can be in the visible light range (e.g., 700 nm-400 nm). The nanostructures can generate pulses of localized optical fields.

The source of energy to which the nanostructures are exposed needs to be capable of providing energy which can be coupled into the SPs of the metallic core via the dopant. For example, the nanoparticles can be exposed to thermal, chemical, electrical or electromagnetic energy can be used. In one embodiment, electromagnetic radiation having a wavelength (or range of wavelengths) that are absorbed by the dopant is used.

In an aspect, the present invention provides a nanostructure capable of providing stimulated emission of radiation from surface plasmons. The nanostructure comprises a metallic structure and a gain medium comprising a matrix and a dopant, where sufficient dopant is in proximity to the metallic core such that the nanoparticle exhibits coherent emission on exposure of the nanoparticle to an energy source. In one embodiment, the nanostructure is a discrete, self-contained nanoparticle comprising a metallic core and a doped shell completely or at least substantially encapsulating the metallic core, where the doped shell comprises a matrix and a dopant. The dopant is in proximity to the metallic core such that the nanoparticle exhibits coherent emission on exposure of the nanoparticle to an energy source. The size of the nanoparticle can be from 2 nm to 200 nm, including all integers and ranges therebetween, if no boundary layer is present. In one embodiment, the present invention provides a composition comprising the nanoparticles.

The metallic structure, e.g., metallic core, is a metallic nanostructure that can support surface plasmon vibrational modes (oscillations). Metallic nanostructures comprising any metal or metal alloy capable of supporting surface plasmons without excess loss are useful in the present invention. For example, metals with an imaginary dielectric component (∈″) of less than 10, and preferably less than or equal to 5 or more preferably less than or equal to 1 are useful. Examples of such metals include Au, Ag, Al, Cu, and alloys of these metals.

The metallic cores can have any shape. For example, the cores can have a spherical shape. The metallic cores can have other shapes, such as ellipsoidal, as well. The longest dimension of the cores is from 1 nm to 100 nm, including all integers and ranges therebetween. In various embodiments, the longest dimension of the metallic core is from nm to 80 nm, 5 nm to 50 nm, 10 nm to 50, or 10 nm to 30 nm. Generally, larger metallic cores have red-shifted surface plasmon oscillations, and such cores have greater losses which must be overcome. An example of metallic cores is gold nanoparticles from 10 nm to 100 nm in diameter, including all integers and ranges therebetween. In one embodiment, the metallic core is a gold nanoparticle 14 nm in diameter. In one embodiment, the size of the metallic cores is such that energy of its surface plasmon oscillations is in the ultraviolet, visible, or near-infrared range. In one embodiment, the energy of the surface plasmon oscillations is in the optical range (a wavelength of 700 nm to 400 nm; 2 eV to 3 eV).

In one embodiment, the metallic core further comprises a boundary layer that stabilizes a colloidal suspension of the metallic cores so that the doped shell can be grown on the cores. For example, a sodium silicate boundary layer that is 1 nm to 2 nm in thickness can be used.

It is considered that the outer doped-shell layer (gain medium) resonantly transfers energy from excited dopant molecules to SP oscillations of the metallic core which results in stimulated emission of SPs in a luminous mode. The doped shell comprises a matrix and a dopant.

The matrix is a dielectric material that provides an environment for the dopant. It is desirable to have dopant molecules within the surface plasmon penetration depth into the gain medium. The penetration depth is dependent on the nature of both the metal and gain medium. Both inorganic dielectric and organic dielectric materials can be matrix materials. Examples of inorganic dielectric matrix materials include, but are not limited to, inorganic glasses (such as silica and the like). Examples of organic dielectric materials include, but are not limited to, polymers (such as polystyrene, polymethylmethacrylate, polycarbonate, and the like). It is desirable that the polymer be insoluble in a solvent (e.g., water), has a glass transition temperature such that the polymer will not deform at operating temperatures such that the characteristics of the nanostructure are adversely affected, and has no absorption or emission characteristics that interfere with the stimulated emission process.

The thickness of the matrix material can be from 1 nm to 100 nm, including all integers and ranges therebetween. In various embodiments, the thickness of the matrix material is from 1 nm to 80 nm, 2 nm to 50 nm, and 2 nm to 25 nm. It is desirable to have as much of the dopant as close to the core as possible, as the surface plasmon intensity decreases as the distance from the outer shell/core interface increases. In one embodiment, the matrix is silica, which can be deposited by, for example, the Stöber synthesis (NH₃ catalyzed reaction of tetraorthosilicate (TEOS; Si(OEt)₄)), which has a thickness of 15 nm.

It is desirable that the matrix provides a rigid environment for the dopant. It is considered that increased rigidity of the matrix reduces non-radiative losses of the dopant, and thus increases the efficiency of the energy transfer from dopant to SP osciallations of the core. To increase the rigidity of the matrix, in one embodiment, the dopant is covalently bound (e.g., directly or via a linking group) to the matrix material. For example, a dopant molecule can be covalently bound to a sol-gel precursor (e.g., a functionalized alkyl(trialkoxy)silane) which is used to produce the doped shell. As another example, the dopant can be functionalized and reacted with the matrix. The dopant and matrix material can be covalently bound by, for example, a carbon-carbon bond, a carbon-oxygen bond, or carbon-nitrogen bond. Covalent bond or bonds between the dopant and matrix can be formed by methods known in the art.

The dopant is a compound or material (or combination of compounds and/or materials) that resonantly transfers energy into the surface plasmon oscillations of the metallic core off-setting any non-radiative losses of the oscillations such that there is a net gain of energy in the surface plasmon oscillations resulting in stimulated emission. There must be at least a partial overlap between the surface plasmon emission band of the core and the emission band(s) of the dopant to allow the coupling of energy into the surface plasmon oscillations. In one embodiment, there is at least a partial overlap between the surface plasmon emission band of the core and the excitation and emission band(s) of the dopant. Additionally, there is a threshold amount of dopant required (e.g., number of dopant molecules—total number of molecules and excited molecules). The amount of dopant required depends on, for example, the spatial distribution of the dopant, the shape and the size of the particle, the metal used as well as the dye used. It is surprising that that the emission of highly concentrated dopant (e.g., dye molecules) has not been quenched. Without intending to be bound by any particular theory, it is considered that the matrix material (e.g., silica) serves as spacers between dopant preventing the dopant from interacting and/or aggregating and adversely affecting the stimulated emission process.

Examples of dopants include, but are not limited to, dyes (e.g., organic dyes) and inorganic materials. Examples of organic dye include, but are not limited to, xanthene derivatives (e.g., fluorescein, rhodamine, Oregon green, eosin, Texas red, and Cal Fluor dyes), cyanine derivatives (e.g., cyanine, indocarbocyanine, oxacarbocyanine, thiacarbocyanine, merocyanine, and Quasar dyes), naphthalene derivatives (e.g., dansyl and prodan derivatives), coumarin derivatives, oxadiazole derivatives (e.g., pyridyloxazole, nitrobenzoxadiazole and benzoxadiazole), pyrene derivatives (e.g., cascade blue), oxazine derivatives (e.g., Nile red, Nile blue, cresyl violet, oxazine 170), acridine derivatives (e.g., proflavin, acridine orange, acridine yellow), arylmethine derivatives (e.g., auramine, crystal violet, malachite green), tetrapyrrole derivatives (e.g., porphin, phtalocyanine and bilirubin), CF™ dye (Biotium), BODIPY® (Invitrogen), ALEXA FLUOR® (Invitrogen), DYLIGHT™ (Thermo Scientific, Pierce), ATTO™ and TRACY™ (Sigma Aldrich), FLUOPROBES® (Interchim), derivatives thereof, and the like. In one embodiment, the dopant is Oregon Green 488, an organic dye. An example of an inorganic material is a nanoparticle, such as a quantum dot.

In one embodiment, the invention provides 44-nm-diameter nanoparticles (spasers) with a gold core and dye-doped silica shell which overcomes the loss of localized surface plasmons by gain. Such a spaser demonstrates outcoupling of surface plasmon oscillations to photonic modes at a wavelength of 531 nm making these spaser nanoparticles the smallest nanolaser and the first operating at visible wavelengths.

The stimulated emission from the spaser nanoparticles of the present invention is coherent. The wavelength of the stimulated emission can be in the ultraviolet, visible, near-infrared range. For example, the stimulated emission can be in the optical wavelength range (i.e., 700 nm to 400 nm or 2 eV to 3 eV). In one embodiment, the spaser has a Au metallic core, and an outer shell of silica doped with a dye (Oregon Green 488). The diameter of this nanoparticle is 44 nm. The wavelength of the stimulated emission from this nanoparticle is 531 nm.

A desired wavelength of stimulated emission can be achieved by appropriate selection of materials and dimensions of the nanoparticle of the present invention. The size and shape of the nanoparticle, especially the metallic core, have a significant effect on the wavelength of the stimulated emission. The thickness and refractive index of the gain medium do not have a significant effect on the wavelength of the stimulated emission.

The present invention also provides a method for preparation of nanoparticles capable of providing stimulated emission. The method comprises providing metal or metallic nanoparticles and depositing a doped shell comprising a matrix material and a dopant. In one embodiment, the method further comprises depositing a boundary layer on the metal or metallic nanoparticles prior to depositing a doped shell. An example of a method for preparation of nanoparticles capable of providing stimulated emission is shown in Example 1.

The metal or metallic nanoparticles can be prepared by methods known in the art. The doped shell can be deposited by methods known in the art. For example, the doped shell can be deposited by sol-gel methods. In one embodiment, the dopant is covalently bound to the sol-gel precursor.

The present invention can be useful for fundamental understanding and applications of nanoplasmonics and nanophotonics. The nanostructure spasers of the present invention provide intense, ultrafast and coherent pulses of nanolocalized optical fields which are desirable for various uses. The emission from individual emitters can be coupled. In one embodiment, the present invention provides a device comprising at least one layer comprising the nanostructure spasers of the present invention. In another embodiment, the present invention provides a device comprising nanostructure spasers of the present invention.

The nanostructure spasers of the present invention have uses ranging across a broad spectrum. Examples of such uses include, but are not limited to, use in optical communication (e.g., transmission and waveguiding through subwavelength structures), nanoscale optical sensing and imaging (e.g., biological and medical applications), computing, metamaterials, lasing applications and lenses.

As integrated circuits continue to shrink, the metal interconnects used between them will not be able to provide the requisite bandwidth without using more and more power. However, as the power consumption of a chip increase, so to does the need to remove the heat created by that power. So-called “optical chips,” which use optical components to move data through a chip, provide a way to increase bandwidth while using less power than traditional electronic methods. Current optical chips use light provided by lasers (on- or off-chip). However, using the nanoparticle spaser technology of the present invention will allow very small, low-power light sources to be placed on-chip. Additionally, many discrete light sources may be used adding flexibility to the design of the optical chip. Combined with other nanophotonic components, like plasmon waveguides, spasers will enable a new generation of miniaturization.

Optical data storage techniques currently use lasers to permit high-density recording of digital data on storage medium by etching small indentations know as “pits.” Typically, the density of pits has been constrained by the type of laser used. For example, the Compact disc (“CD”) format uses a 780 nm laser and can store approximately 700 megabytes of data, Digital Versatile Disc (“DVD”) uses 650 nm to store 4.7 gigabytes; and Blu-ray uses 405 nm to store 25 gigabytes, each on a similar-sized disc. By using nanoparticle spasers of the present invention as light sources to etch data onto the storage medium, the pit size (and thus density) can be further controlled to enable storage capacities exceeding even that of Blu-ray discs.

Nanoparticle spasers may be also be used in chemical and biosensing applications and other spectroscopy applications. For example, by using a nanoparticle spaser of the present invention to impact a sample and cause Raman scattering (e.g., Surface Enhanced Raman Scattering can be carried out with greatly reduced laser power and time). A detector may measure the scattering and, in this manner, the sample may be identified. Using spasers as the energy source in such applications, detection/identification can be made on the single molecule scale. Other potential applications of spasers include use with other metamaterials and near-field optical microscopy with spaser light sources used in the sensing probe.

The following examples are presented to illustrate the present invention. They are not intended to limiting in any manner.

### Example 1

### Preparation and Characterization of a SPASER Nanoparticle

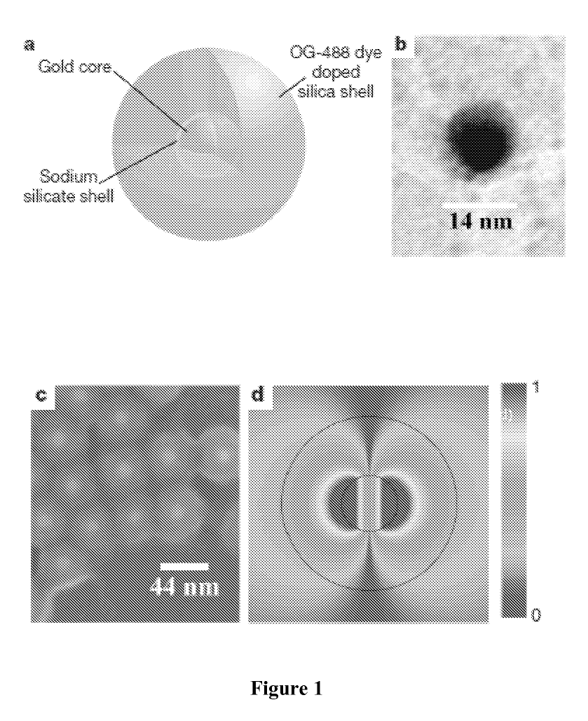

One embodiment of the invention is presented in the following. A spaser should have a medium with optical gain in close vicinity to a metallic nanostructure that supports surface plasmon oscillations. To realize such a structure, a modified synthesis technique for high-brightness luminescent core-shell silica nanoparticles known as Cornell dots was employed. As illustrated in FIG. 1a, the produced nanoparticles are composed of a gold core providing for plasmon modes, surrounded by a silica shell containing the organic dye Oregon Green 488 (OG-488).

Transmission and scanning electron microscopy measurements give the diameter of the Au core and the thickness of the silica shell as -14 nm and -5 nm, respectively (FIG. 1b, c). The number of dye molecules per nanoparticle was estimated to be 2.7×10³ and the nanoparticle concentration in a water suspension was equal to 3×10¹¹ cm⁻³ (Methods). A calculation of the spaser mode of this system (FIG. 1d) yields a stimulated emission wavelength of 525 nm and a quality (Q)-factor of 14.8 (Methods). It should be noted that in gold nanoparticles as small as the ones used here, the Q-factor is dominated by absorption. But as shown below, the gain in our system is high enough to compensate the loss.

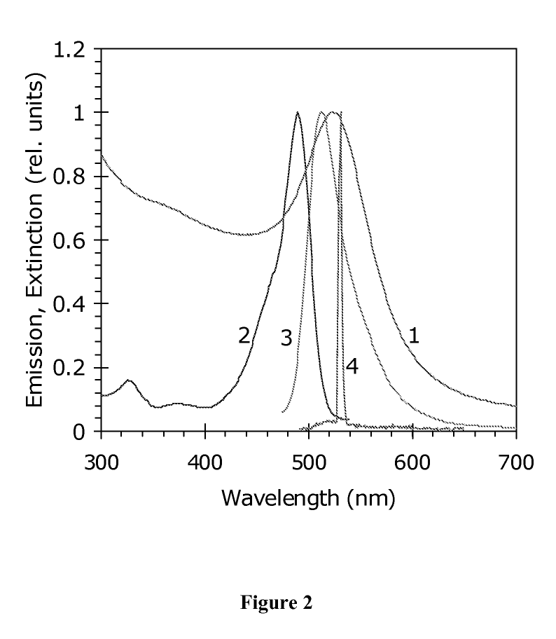

The extinction spectrum of a suspension of nanoparticles shown in FIG. 2 is dominated by the surface plasmon resonance band at −520 nm wavelength and the broad short-wavelength band corresponding to interstate transitions between d states and hybridized s-p states of Au. The Q-factor of the surface plasmon resonance is estimated from the width of its spectral band as 13.2, in good agreement with the calculations. The spectra in FIG. 2 also illustrate that the surface plasmon band overlaps with both the emission and excitation bands of the dye molecules incorporated in the nanoparticles.

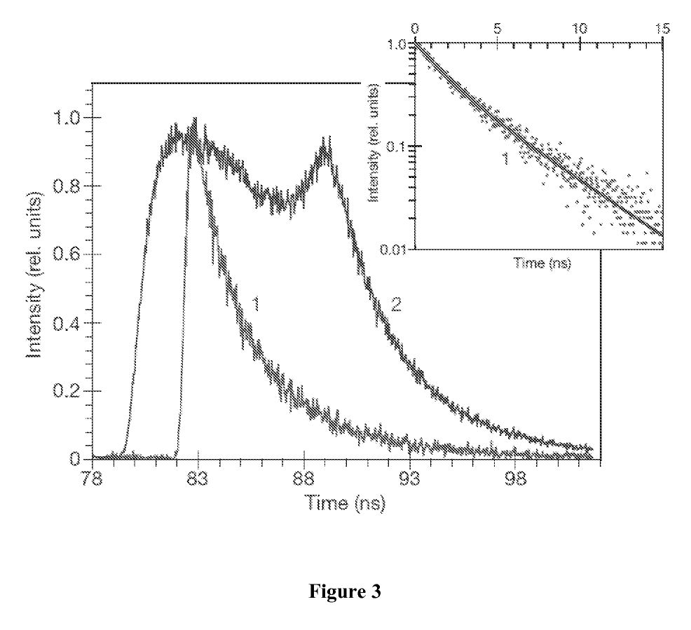

As illustrated in FIG. 3, the decay kinetics of the emission at 480 nm were non-exponential. Fitting the data with the sum of two exponentials resulted in two characteristic decay times, 1.6 ns and 4.1 ns. The absorption and emission spectra of OG-488 (FIG. 2) are nearly symmetrical to each other, as expected of dyes, and this allows an assumption that the peak emission cross-section, σₑₘ, is equal to the peak absorption cross-section, σ_{abs}=2.55×10¹⁶ cm², determined from the absorption spectrum of OG-488 in water at known dye concentration. With this value and using the known formula relating the strength and the width of the emission band with the radiative lifetime τ, an estimated radiative life-time of τ=4.3 ns that is very close to that of the slower component of the experimentally determined emission kinetics was obtained. It can be inferred that the decay-time shortening (down to 1.6 ns) seen with the dye molecules in the effective plasmonic nanocavity described herein can be explained by the Purcell effect.

When the emission was detected in the spectral band 520±20 nm (which encompasses the maximum of the emission and gain), it first decayed and then developed a second peak (FIG. 3) that is characteristic of the development of a stimulated emission pulse and consistent with the spaser effect (see below). In fact, both the delay of the stimulated emission pulse relative to the pumping pulse and the oscillating behavior of the stimulated emission (relaxation oscillations) are known in lasers; and because these phenomena do not depend on the nature of the oscillating mode, they are expected in spasers as well.

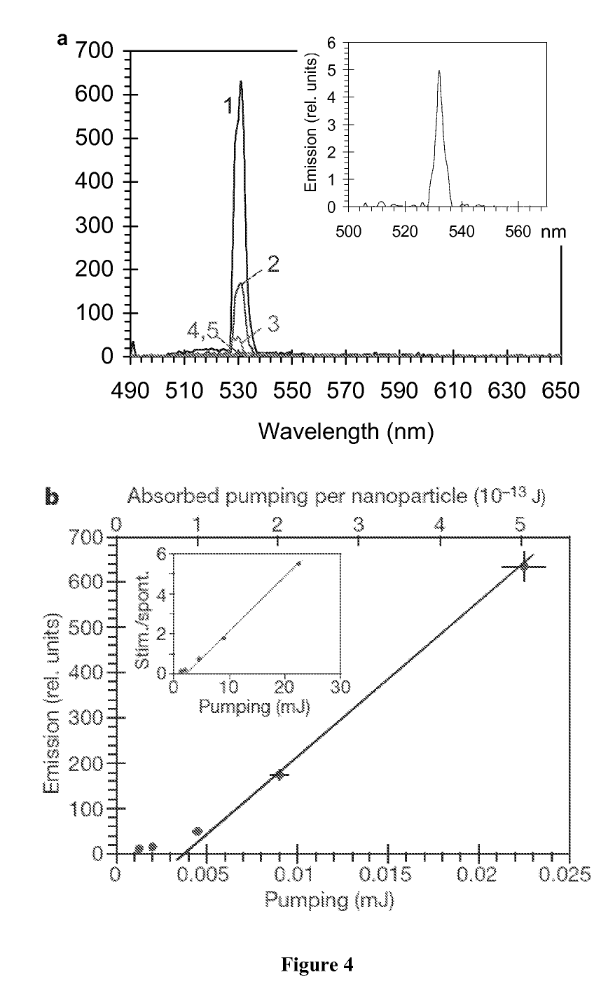

To study the stimulated emission, samples were loaded in cuvettes of 2 mm path length and pumped at wavelength λ=488 nm with ˜5-ns pulses from an optical parametric oscillator lightly focused into a ˜2.4-mm spot. Whereas the emission spectra resembled those measured in the spectrofluorometer (FIG. 2) at weak pumping, a narrow peak appeared at λ=531 nm (FIG. 4a) once the pumping energy exceeded a critical threshold value. FIG. 4b gives the intensity of this peak as a function of pumping energy, yielding an input-output curve with a pronounced threshold characteristic of lasers. The ratio of the intensity of this laser peak to the spontaneous emission background increased with increasing pumping energy (FIG. 4b inset). By analogy with lasers, the dramatic change of the emission spectrum above the threshold (from a broad band to a narrow line) suggests that the majority of excited molecules contributed to the stimulated emission mode. The laser-like emission occurred at a wavelength at which the dye absorption, as evidenced by the excitation spectrum, is practically absent while the emission and the surface plasmon resonance are strong (see FIG. 2).

Diluting the sample more than 100-fold decreased the emission intensity, but did not change the character of the spectral line (FIG. 4a inset) or diminish the ratio of stimulated emission intensity to spontaneous emission background. We conclude from this that the observed stimulated emission was produced by single nanoparticles, rather than being a collective stimulated emission effect in a volume of gain medium with the feedback supported by the cuvette walls.

The spontaneous emission intensity of a 0.235 mM aqueous solution of OG-488 dye was approximately 1,000 times stronger than that of the lasing nanoparticle sample. But under pumping, the dye solution did not show spectral narrowing or superlinear dependence of the emission intensity on pumping power. The dependence of the emission intensity on pumping power was in fact sublinear, which could be a result of dye photo-bleaching. This control result is further evidence that the stimulated emission occurs in individual hybrid Au/silica/dye nanoparticles, rather than in the macroscopic volume of the cuvette.

The diameter of the hybrid nanoparticle (hybrid Cornell dot) is 44 nm-too small to support visible stimulated emission in a purely photonic mode. But modeling of the system predicts that stimulated emission can be supported by the surface plasmon mode if the number of excited dye molecules per nanoparticle exceeds 2.0×10³ (Methods); this number is smaller than the number of OG-488 molecules available per nanoparticle in the experimental sample, which is ˜2.7×10³. The pumping photon flux in our measurements (˜10²⁵ cm⁻² s⁻¹) exceeds the saturation level for OG-488 dye molecules (˜10²⁴ cm⁻² s⁻¹), so almost all the dye molecules were excited. The gain in the system was thus sufficiently large to overcome the overall loss, enabling the first experimental demonstration of a spaser, which we report here and regard as the central finding of the present work. But another important result is that the outcoupling of surface plasmon oscillations to photonic modes (facilitated by the radiative damping of the localized surface plasmon mode) constitutes a nanolaser that is realized by each individual nanoparticle, making it the smallest reported in the literature and the only one to date operating in the visible range.

The demonstrated phenomenon involves resonant energy transfer from excited molecules to surface plasmon oscillations and stimulated emission of surface plasmons in a luminous mode. We note that this phenomenon is very different from that exploited in quantum cascade lasers, in which the surface plasmon mode (almost indistinguishable at the mid-infrared wavelength and the geometry of the experiment from the photonic transverse electromagnetic mode) is used as a guiding mode in an otherwise normal laser cavity. In contrast, in the reported spaser, the oscillating surface plasmon mode provides for feedback needed for stimulated emission of localized surface plasmons. The ability of the spaser to actively generate coherent surface plasmons could lead to new opportunities for the fabrication of photonic metamaterials, and have an impact on technological developments seeking to exploit optical and plasmonic effects on the nanometer scale.

### Methods

Particle Synthesis and Cleaning.

Gold cores with a thin sodium silicate shell were prepared according to previously published methods and transferred into a basic ethanol (1 μl ammonium hydroxide per ml of ethanol) solution via dilution (1:4). Tetraethoxysilane was added (1 μl per 10 ml of Stöber synthesis solution) to grow a thick silica shell. Ten microlitres of OG-488 isothiocyanate or maleimide (Invitrogen, dissolved to 4.56 mM concentration in dimethylsulphoxide), were conjugated to 3-isocyanatopropyltriethoxysilane (ICPTS) or 3-mercaptopropyltrimethoxysilane (MPTMS), respectively in a 1:50 molar ratio (dye:ICPTS or dye:MPTMS) in an inert atmosphere and added to the aforementioned 10 ml of Stöber synthesis solution. The particles were cleaned by centrifugation and resuspended in water. The concentration of nanoparticles in the suspension, approximately 3×10¹¹ cm⁻³, was calculated from the gold wt % measurements provided by Elemental Analysis, Inc. The number of dye molecules per particle, 2.7×10³, was estimated on the basis of the known concentration of nanoparticles, the starting concentration of dye molecules used in the reaction, and the concentration of dye molecules which remained in the solution after the synthesis.

Theoretical Model.

To calculate the cold-cavity modes in the system, the structure is modeled as a spherical silica shell (with refractive index of 1.46) with a gold core, whose frequency-dependent dielectric permittivity is taken from ref. 28 (FIG. 1a). The corresponding three-dimensional wave equation can be solved analytically using Debye potentials, which yields a sequence of localized plasmon modes with different values of total angular momentum l and its projection m(m=−l, . . . , 0, . . . , l). The experimental wavelength range λ≈530 nm corresponds to the lowest frequency modes of this sequence, l=1, which are triply degenerate (m=−1, 0, 1). This degeneracy (similar to that in the p state of the hydrogen atom) can be visualized in relation to a different direction of the mode ‘axis’ (FIG. 1d) and will be lifted by a deviation from spherical symmetry in the particle geometry. The resulting cold-cavity l=1 mode wavelength (calculated with no fitting parameters) is 525 nm and the Q-factor is 14.8 (where the primary contribution originates from the losses in the gold core).

For the active system, the gain is taken into account in the imaginary part of the refractive index of the silica shell, with the magnitude calculated using standard expressions of refs 24, 29, and from the known value of the stimulated emission cross-section of OG-488 molecules and their density. In this approach, the lasing threshold relates to the zero of the imaginary part of the mode frequency (corresponding to infinite lifetime). Assuming that the active molecules are uniformly distributed from the core to the diameter of 24 nm (in the 44-nm diameter silica shell), we find that the stimulated emission requires ˜2,000 active molecules.

Emission Kinetics Measurements.

Emission decay kinetics were measured using a fluorescence lifetime imaging microscope (Microtime 200). The samples were excited at A=466 nm with <90 ps laser pulses at 40 MHz repetition rate. The emission was taken from the side of the pumping in an inverted microscope set-up (an immersion objective lens, a coverslip and a droplet of sample on the coverslip). The diameter and the depth of the focused laser beam were 0.24 μm and 1 μm, respectively, and the pumping power density was 9.8×10⁵ W cm⁻² (4.2×10⁴ W cm⁻²) when the emission was detected in the 480±5 nm (520±20 nm) spectral band. The response time of the detector was shorter than 300 ps. The fit of the emission kinetics detected at 480 nm with the sum of two exponents resulted in I(t)αa₁ exp(−t/τ₁)+a₂ exp(−t/τ₂), with a₁=0.48, a₂=0.52, τ₁=1.6 ns and τ₂=4.1 ns. Given the experimental noise, the characteristic decay times are determined with ±10% accuracy.

The observation of the stimulated emission kinetics (FIG. 2, trace 2) from such a tiny volume, which can provide for only very small amplification, is additional proof of the spaser and nanolaser effects occurring in individual nanoparticles.

Radiative Life-Time.

Evaluation of the radiative life-time from the emission spectra was performed using the known formula

$${σ}_{cm} ( λ ) = \frac{{λ}^{5} I ( λ )}{8 π {n}^{2} c τ \int λ I ( λ ) d λ}$$

where λ is the wavelength, I(λ) is the emission intensity, n is the index of refraction, and c is the speed of light.

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1) A nanoparticle capable of providing stimulated coherent emission of radiation from surface plasmons comprising:
a) a metallic core which supports surface plasmon oscillations; and
b) an outer shell comprising a matrix and a dopant,
wherein the dopant has a dopant emission band,
wherein there is at least partial overlap between the surface plasmon emission band of the core and the dopant emission band, and
wherein sufficient dopant is in proximity to the metallic core,
such that the nanoparticle exhibits emission of coherent radiation upon exposure of the nanoparticle to an energy source.

2) The nanoparticle of claim 1, further comprising a boundary layer disposed between the metallic core and outer shell.

3) The nanoparticle of claim 2, wherein the boundary layer comprises sodium silicate and the thickness of the boundary layer is 1 nm to 2 nm.

4) The nanoparticle of claim 1, wherein the metallic core comprises a metal with an imaginary dielectric component (∈″) of less than 10.

5) The nanoparticle of claim 1, wherein the metallic core comprises a metal selected from Au, Ag, Al, Cu and combinations thereof.

6) The nanoparticle of claim 1, wherein the longest dimension of the metallic core is from 1 nm to 100 nm.

7) The nanoparticle of claim 1, wherein the matrix is an inorganic dielectric material or an organic dielectric material.

8) The nanoparticle of claim 7, wherein the inorganic dielectric material is silica.

9) The nanoparticle of claim 1, wherein the thickness of the outer shell is from 1 nm to 100 nm.

10) The nanoparticle of claim 1, wherein the dopant is an organic dye.

11) The nanoparticle of claim 1, wherein the coherent radiation is in the visible wavelength range.

12) The nanoparticle of claim 1, wherein there is a covalent bond between the dopant and the matrix.

13) A method for producing coherent emission from a nanoparticle comprising the steps of:
a) providing a nanoparticle comprising:
i) a metallic core which supports surface plasmon oscillations; and
ii) an outer shell comprising a matrix and a dopant,
wherein the dopant has a dopant emission band,
wherein there is at least partial overlap between the surface plasmon emission band of the core and the dopant emission band, and
wherein sufficient dopant is in proximity to the metallic core, and
b) exposing the nanostructure to energy such that the dopant transfers energy to the surface plasmon oscillations of the metallic core resulting in coherent emission from the nanoparticle.

14) The method of claim 13, wherein longest dimension of the nanoparticle is from 2 nm to 200 nm.

15) The method of claim 13, wherein the nanoparticle further comprises a boundary layer disposed between the metallic core and outer shell.

16) The method of claim 13, wherein the metallic core comprises a metal selected from Au, Ag, Al, Cu and combinations thereof.

17) The method of claim 13, wherein the matrix is an inorganic dielectric material or an organic dielectric material.

18) The method of claim 17, wherein the inorganic dielectric material is silica.

19) The method of claim 13, wherein the dopant is an organic dye.

20) The method of claim 13, wherein there is a covalent bond between the dopant and the matrix.
